(19) United States
(12) Patent Application Publication
(10) Pub. No.: US 2019/0286351 A1
(43) Pub. Date: Sep. 19, 2019

(54) METHOD FOR CONFIGURING HOST MEMORY BUFFER, MEMORY STORAGE APPARATUS AND MEMORY CONTROL CIRCUIT UNIT

(71) Applicant: PHISON ELECTRONICS CORP., Miaoli (TW)

(72) Inventors: Hsiao-Chi Ho, Hsinchu County (TW); Cheng-Nan Wu, Kaohsiung City (TW); Chien-Hua Chu, Hsinchu County (TW)

(73) Assignee: PHISON ELECTRONICS CORP., Miaoli (TW)

(21) Appl. No.: 15/978,198

(22) Filed: May 14, 2018

(30) Foreign Application Priority Data
Mar. 14, 2018 (TW) 107108606

(51) Int. Cl. G06F 3/06; G06F 12/02

(52) U.S. Cl. CPC G06F 3/0632; G06F 3/0631; G06F 12/0246; G06F 11/1441; G06F 3/0656; G06F 3/0659; G06F 3/0679; G06F 3/0604

(57) ABSTRACT

A method for configuring host memory buffer, a memory storage apparatus and a memory control circuit unit are provided. The method includes: loading an initial program stored in an option ROM of a memory storage apparatus to a buffer memory of a host system; executing the initial program to configure continuous physical addresses in the buffer memory as a host memory buffer of the memory storage apparatus and setting a signature at the continuous physical addresses and storing the signature. The method further includes: re-establishing a link with the continuous physical addresses when receiving a reset command corresponding to a suspend-to-RAM mode and determining whether a signature set at the continuous physical addresses is the same as the stored signature; and resuming to use the continuous physical addresses as the host memory buffer of the memory storage apparatus if the signature is the same as the stored signature.

### CROSS-REFERENCE TO RELATED APPLICATION

This application claims the priority benefit of Taiwan application serial no. 107108606, filed on Mar. 14, 2018. The entirety of the above-mentioned patent application is hereby incorporated by reference herein and made a part of this specification.

### BACKGROUND

### 1. Technical Field

The present disclosure relates to a method for configuring a host memory buffer, a memory storage apparatus, and a memory control circuit unit.

### 2. Description of Related Art

In order for memory storage apparatuses of different functions to maximize the performance of an electronic apparatus, the host system nowadays provides a host memory buffer for the memory storage apparatuses. Taking a solid state drive (SSD) having a storage capacity of 1 TB as an example, the host system may provide a storage space of about 1 GB as the host memory buffer, for example. When configuring the host memory buffer, there are generally two time points at which the host system drives the host memory buffer, i.e., when a memory storage apparatus found is driven and loaded and when a memory storage is reset due to an anomaly or when a reset is triggered by a command during an operation.

To facilitate the performance of the electronic apparatus, it is common to add a memory storage apparatus to the host system. Through self-defined commands in an option read-only memory and the SSD drive, a driving layer of the host system may provide the host memory buffer having continuous physical addresses for the memory storage apparatus based on a memory storage apparatus configuration parameter during a driving and loading process of the memory storage apparatus, so that the host system may access the memory storage apparatus and a specific location of the memory storage apparatus through the configured host memory buffer. Besides, the memory is released back to the host system when the memory storage apparatus is reset or removed.

During the process, the host system may communicate with the memory storage apparatus via the driving layer. Hence, the driving layer of the host system needs to be compatible with the driver of the memory storage apparatus. Otherwise, the memory storage apparatus is unable to be driven to be initialized, or the memory having continuous physical addresses is unable to be configured for the memory storage apparatus. Moreover, in order to configure the host memory buffer through the driving layer, a corresponding driver needs to be installed in the host system. Thus, if the user does not install the driver in the host system, the function of the host memory buffer is unable to be initialized, which may cause the user's inconvenience.

Nothing herein should be construed as an admission of knowledge in the prior art of any portion of the present disclosure. Furthermore, citation or identification of any document in this application is not an admission that such document is available as prior art to the present disclosure, or that any reference forms a part of the common general knowledge in the art.

### SUMMARY

The present disclosure provides a method for configuring a host memory buffer, a memory storage apparatus, and a memory control circuit unit. The present disclosure does not require a driving layer to be compatible with a driver of the memory storage apparatus to realize a flexible configuration of a host memory buffer.

An exemplary embodiment of the present disclosure provides a method for configuring a host memory buffer. The method includes loading an initial program stored in an option read-only memory of a memory storage apparatus to a buffer memory of a host system; executing the initial program to configure continuous physical addresses in the buffer memory of the host system for the memory storage apparatus as a host memory buffer of the memory storage apparatus; setting a signature at the continuous physical addresses and storing the signature.

An exemplary embodiment of the present disclosure provides a memory storage apparatus. The memory storage apparatus includes a connection interface unit, a rewritable non-volatile memory module, an option read-only memory, and a memory control circuit unit. The connection interface unit is configured to be electrically connected to a host system. The option read-only memory is configured to store an initial program. When the host system is powered on, the initial program is loaded to a buffer memory of the host system and the initial program is executed to configure continuous physical addresses in the buffer memory of the host system as a host memory buffer, and a signature is set at the continuous physical addresses. The memory control circuit unit is electrically connected to the option read-only memory, the connection interface unit, and the rewritable non-volatile memory module and configured to store the signature.

A memory control circuit unit according to an exemplary embodiment of the present disclosure includes a host interface, a memory interface, and a memory management circuit. The host interface is configured to be electrically connected to a host system, and the memory interface is configured to be electrically connected to the rewritable non-volatile memory module and the option read-only memory. The option read-only memory stores an initial program. When the host system is powered on, the initial program is loaded to a buffer memory of the host system and the initial program is executed to configure continuous physical addresses in the buffer memory of the host system as a host memory buffer, and a signature is set at the continuous physical addresses. The memory management circuit is electrically connected to the host interface and the memory interface and configured to store the signature.

Based on the above, according to the method for configuring the host memory buffer, the memory storage apparatus, and the memory control circuit unit of the exemplary embodiments of the disclosure, the host memory buffer is flexibly configured after the host system is reset from a sleep mode by using the option read-only memory and based on the memory configuration parameter of the memory storage apparatus.

In order to make the aforementioned and other features and advantages of the disclosure comprehensible, several exemplary embodiments accompanied with figures are described in detail below.

It should be understood, however, that this Summary may not contain all of the aspects and embodiments of the present disclosure, is not meant to be limiting or restrictive in any manner, and that the disclosure as disclosed herein is and will be understood by those of ordinary skill in the art to encompass obvious improvements and modifications thereto.

### BRIEF DESCRIPTION OF THE DRAWINGS

FIG. 1 is a schematic diagram illustrating a host system, a memory storage apparatus, and an input/output (I/O) apparatus according to an exemplary embodiment.

FIG. 2 is a schematic diagram illustrating a host system, a memory storage apparatus, and an input/output (I/O) apparatus according to another exemplary embodiment.

FIG. 3 is a diagram illustrating a host system and a flash memory storage apparatus according to another exemplary embodiment.

FIG. 4 is a schematic block diagram illustrating a host system and a memory storage apparatus according to an exemplary embodiment.

FIG. 5 is a schematic block diagram illustrating a memory control circuit unit according to an exemplary embodiment.

FIG. 6 is a schematic block diagram illustrating a host system and a memory storage apparatus according to an exemplary embodiment.

FIG. 7 is a schematic flowchart illustrating configuring a host memory buffer after a host system is powered on according to an exemplary embodiment.

FIG. 8 is a schematic flowchart when a memory control circuit unit receives a reset command corresponding to a suspend-to-RAM mode according to an exemplary embodiment.

FIG. 9 is a schematic flowchart when a memory control circuit unit receives a reset command of a suspend-to-disk mode or a warm reset command according to an exemplary embodiment.

FIG. 10 is a schematic flowchart when a memory control circuit unit receives a reset command corresponding to a power-off state according to an exemplary embodiment.

FIG. 11 is a schematic flowchart illustrating that a memory control circuit unit determines whether a memory storage apparatus is shut down normally according to an exemplary embodiment.

### DESCRIPTION OF THE EMBODIMENTS

Reference will now be made in detail to the present preferred embodiments of the disclosure, examples of which are illustrated in the accompanying drawings. Wherever possible, the same reference numbers are used in the drawings and the description to refer to the same or like parts.

Embodiments of the present disclosure may comprise any one or more of the novel features described herein, including in the Detailed Description, and/or shown in the drawings. As used herein, “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

It is to be noted that the term “a” or “an” entity refers to one or more of that entity. As such, the terms “a” (or “an”), “one or more” and “at least one” can be used interchangeably herein.

Generally speaking, a memory storage apparatus (i.e., a memory storage system) includes a rewritable non-volatile memory module and a controller (i.e., a control circuit unit). The memory storage apparatus is usually used together with a host system, such that the host system can write data into or read data from the memory storage apparatus.

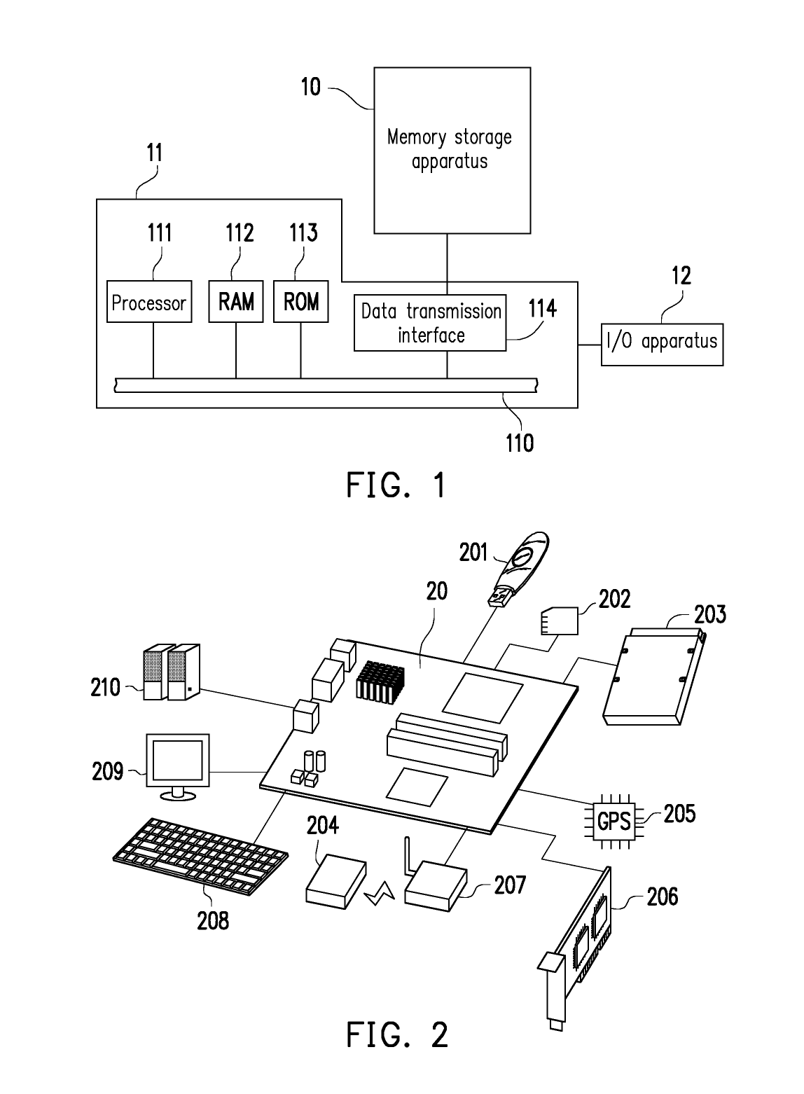

FIG. 1 is a schematic diagram illustrating a host system, a memory storage apparatus, and an input/output (I/O) apparatus according to an exemplary embodiment, and FIG. 2 is a schematic diagram illustrating a host system, a memory storage apparatus, and an input/output (I/O) apparatus according to another exemplary embodiment.

Referring to FIGS. 1 and 2, a host system 11 includes a processor 111, a random access memory (RAM) 112, a read only memory (ROM) 113, and a data transmission interface 114. The processor 111, the random access memory 112, the read only memory 113, and the data transmission interface 114 are coupled to a system bus 110.

In the exemplary embodiment, the host system 11 is coupled to a memory storage apparatus 10 through the data transmission interface 114. For example, the host system 11 may write data to or read data from the memory storage apparatus 10 through the data transmission interface 114. In addition, the host system 11 is coupled to the I/O apparatus 12 through the system bus 110. For example, the host system 11 may transmit output signals to or receive input signals from the I/O apparatus 12 through the system bus 110.

In the present exemplary embodiment, the processor 111, the random access memory 112, the read only memory 113, and the data transmission interface 114 may be disposed on a motherboard 20 of the host system 11. One or more data transmission interfaces 114 may be provided. Through the data transmission interface 114, the motherboard 20 may be coupled to the memory storage apparatus 10 in a wired or wireless manner. The memory storage apparatus 10 may be a flash drive 201, a memory stick 202, a solid state drive (SSD) 203, or a wireless memory storage apparatus 204, for example. The wireless memory storage apparatus 204 may be a memory storage apparatus based on a variety of wireless communication technologies, such as a near field communication (NFC) memory storage apparatus, a wireless fidelity (WiFi) memory storage apparatus, a Bluetooth memory storage apparatus, or a Bluetooth low energy memory storage apparatus (e.g., iBeacon), etc. In addition, the motherboard 20 may be coupled to an I/O apparatus of any kind, such as a global positioning system (GPS) module 205, a network interface card 206, a wireless transmission apparatus 207, a keyboard 208, a monitor 209, a speaker 210, etc., through the system bus 110. For example, in an exemplary embodiment, the motherboard 20 may access the wireless memory storage apparatus 204 through the wireless transmission apparatus 207.

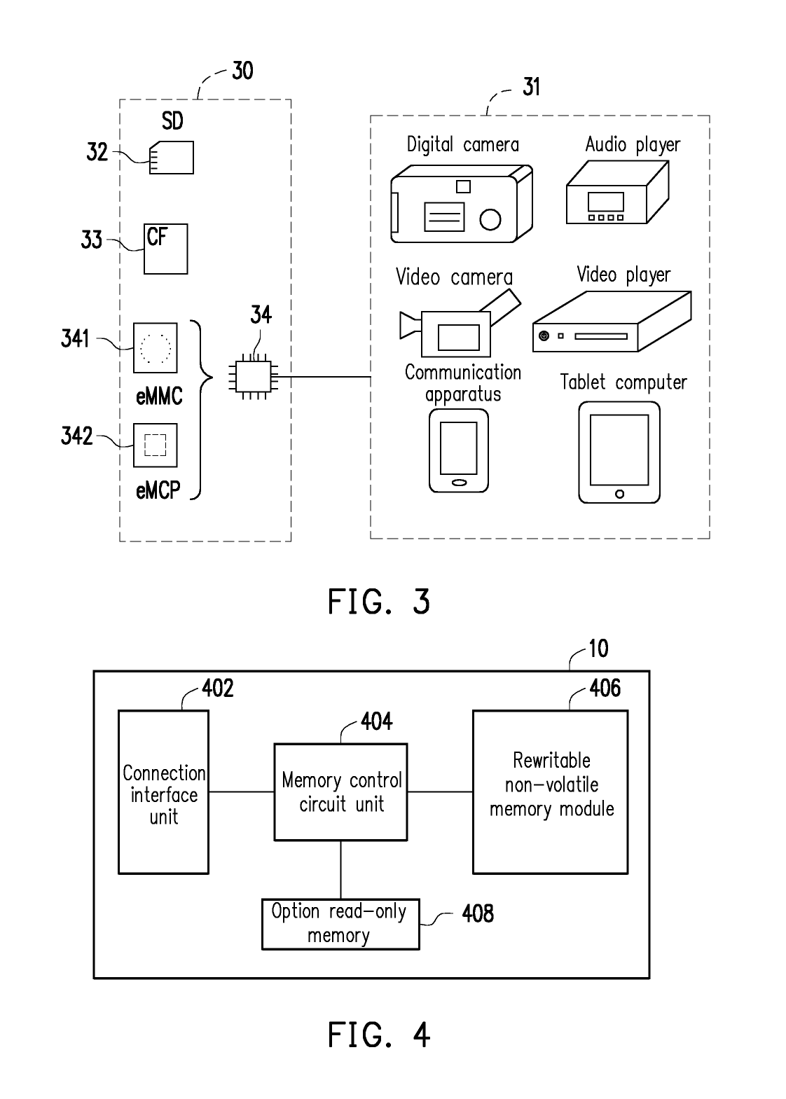

In an exemplary embodiment, the host system may be any system substantially capable of being used with a memory storage apparatus to store data. Even though the host system is described as a computer system in the exemplary embodiment, FIG. 3 is a schematic view illustrating a host system and a memory storage apparatus according to another exemplary embodiment. Referring to FIG. 3, in the exemplary embodiment, a host system 31 may also be a system such as a digital camera, a video camera, a communication apparatus, an audio player, a video player, or a tablet computer, etc., and a memory storage apparatus 30 may be a non-volatile memory storage apparatus of any kind, such as a secure digital (SD) card 32, a compact flash (CF) card 33, or an embedded storage apparatus 34, etc. The embedded storage apparatus 34 includes an embedded storage apparatus of any kind, where a memory module of any kind is directly coupled to a substrate of the host system, such as an embedded multimedia card (eMMC) 341 and/or an embedded multi-chip package (eMCP) storage apparatus 342.

FIG. 4 is a schematic block diagram illustrating a host system and a memory storage apparatus according to an exemplary embodiment.

Referring to FIG. 4, the memory storage apparatus 10 includes a connection interface unit 402, a memory control circuit unit 404, a rewritable non-volatile memory module 406, and an option read-only memory (option ROM) 408.

In the present exemplary embodiment, the connection interface unit 402 is compatible with the Secure Digital (SD) interface standard. However, the disclosure is not limited thereto. The connection interface unit 402 may also be compatible with the Serial Advanced Technology Attachment (SATA) standard, the Parallel Advanced Technology Attachment (PATA) standard, the Institute of Electrical and Electronic Engineers (IEEE) 1394 standard, the Peripheral Component Interconnect Express (PCI Express) standard, the Universal Serial Bus (USB) standard, the Ultra High Speed-I (UHS-I) interface standard, the Ultra High Speed-II (UHS-II) interface standard, the Memory Stick (MS) interface standard, the Multi-chip Package interface standard, the Multimedia Card (MMC) interface standard, the Embedded Multimedia Card (eMMC) interface standard, the Universal Flash Storage (UFS) interface standard, the Embedded Multi-chip Package (eMCP) interface standard, the Compact Flash (CF) interface standard, the Integrated Device Electronics (IDE) standard, or other suitable standards. In the present exemplary embodiment, the connection interface unit 402 may be packaged with the memory control circuit unit 404 within the same chip, or the connection interface unit 402 may be disposed outside a chip that includes the memory control circuit unit.

The memory control circuit unit 404 may execute a plurality of logical gates or control commands implemented in a hardware form or a firmware form, and may perform data writing, reading, and erasing operations on the rewritable non-volatile memory module 406 according to commands of the host system 11. For example, the memory control circuit unit 404 may include a microprocessor (not shown) and a register (not shown). When the data writing, reading, or other operations are performed on the rewritable non-volatile memory module 406 based on the command of the host system 11, the register may temporarily store data relating to a data write command, a data read command, or other operation commands.

The rewritable non-volatile memory module 406 is coupled to the memory interface control circuit 404 and stores data written by the host system 11. The rewritable non-volatile memory module 406 may be a single level cell (SLC) NAND flash memory module (i.e., a flash memory module where one memory cell stores one bit), a multi-level cell (MLC) NAND flash memory module (i.e., a flash memory module where one memory cell stores two bits) a triple level cell (TLC) NAND flash memory module (i.e., a flash memory module where one memory cell stores three bits), other flash memory modules, or other memory modules having the same property.

The option read-only memory (option ROM) 408 is coupled to the memory control circuit unit 404, and stores a firmware component allowing an operation, such as a power-on self-test (POST), an initialization operation, or the like, to be carried out. The memory control circuit unit 404 may execute a POST program, an initial program, or the like stored in the option read-only memory 408 to carry out the power-on self-test (POST), the initialization operation, or the like.

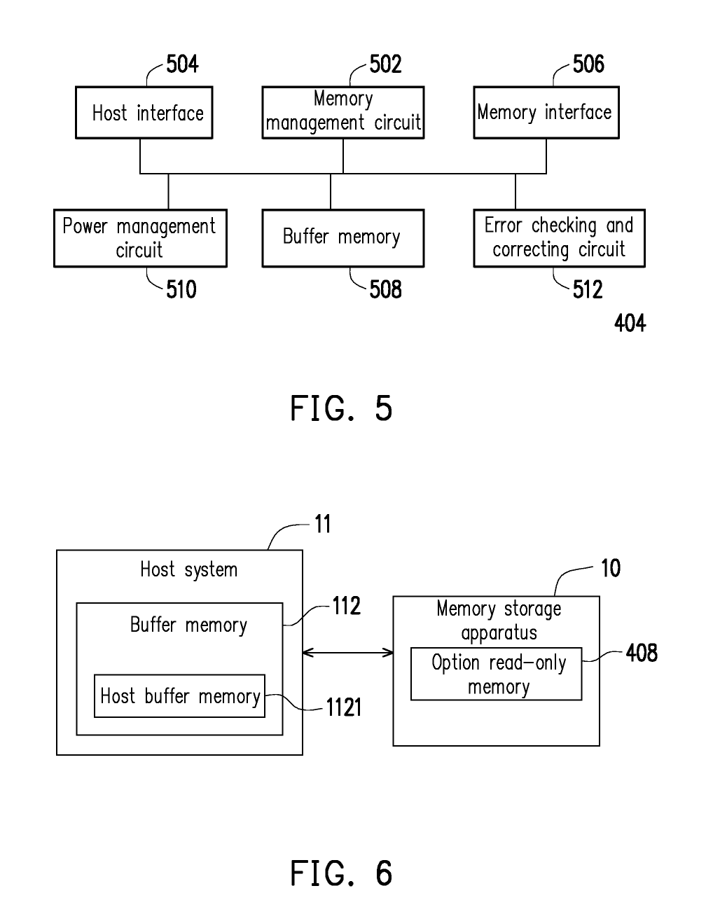

FIG. 5 is a schematic block diagram illustrating a memory control circuit unit according to an exemplary embodiment.

Referring to FIG. 5, the memory control circuit unit 404 includes a memory management circuit 502, a host interface 504, and a memory interface 506.

The memory management circuit 502 may control an overall operation of the memory control circuit unit 404. Specifically, the memory management circuit 502 has a plurality of control commands. When the memory storage apparatus 10 is operated, the control commands are executed to perform various data operations such as data writing, data reading and data erasing.

In the present exemplary embodiment, the control commands of the memory management circuit 502 are implemented in a firmware form. For instance, the memory management circuit 502 has a microprocessor (not shown) and a read-only memory (not shown), and the control commands are burnt into the read-only memory. When the memory storage apparatus 10 is operated, the control commands are executed by the microprocessor to perform various data operations, such as data writing, data reading or data erasing.

According to another exemplary embodiment of the present disclosure, the control commands of the memory management circuit 502 may also be stored in a specific area (e.g., a system area in a memory module exclusively used for storing system data) of the rewritable non-volatile memory module 406 as program codes. Moreover, the memory management circuit 502 has a microprocessor (not shown), a read-only memory (not shown), and a random access memory (not shown). Specifically, the read-only memory has a boot code. When the memory control circuit unit 404 is enabled, the boot code is firstly executed by the microprocessor to load the control commands stored in the rewritable non-volatile memory module 406 into the random access memory of the memory management circuit 502. Afterwards, the microprocessor executes the control commands for various data operations such as data writing, data reading and data erasing.

Additionally, according to another exemplary embodiment of the present disclosure, the control commands of the memory management circuit 502 may be implemented in a hardware form. For example, the memory management circuit 502 may include a microcontroller, a memory cell management circuit, a memory write circuit, a memory read circuit, a memory erase circuit, and a data processing circuit. The memory management circuit, the memory write circuit, the memory read circuit, the memory erase circuit, and the data processing circuit are coupled to the microcontroller. In addition, the memory cell management circuit may manage physical erasing units of the rewritable non-volatile memory module 406. The memory write circuit may issue a write command to the rewritable non-volatile memory module 406 to write data into the rewritable non-volatile memory module 406. The memory read circuit may issue a read command to the rewritable non-volatile memory module 406 to read data from the rewritable non-volatile memory module 406. The memory erase circuit may issue an erase command to the rewritable non-volatile memory module 406 to erase data from the rewritable non-volatile memory module 406. The data processing circuit may process data to be written into the rewritable non-volatile memory module 406 and data to be read from the rewritable non-volatile memory module 406.

The host interface 504 is coupled to the memory management circuit 502 and may be coupled to the connection interface unit 402 to receive and identify the commands and data transmitted by the host system 11. In other words, the commands and data sent by the host system 11 are transmitted to the memory management circuit 502 through the host interface 504. In the present exemplary embodiment, the host interface 504 is compatible with the SATA standard. However, it should be understood that the present disclosure is not limited thereto. The host interface 504 may also be compatible with the PATA standard, the IEEE 1394 standard, the PCI Express standard, the USB standard, the UHS-I interface standard, the UHS-II interface standard, the SD standard, the MS standard, the MMC standard, the CF standard, the IDE standard, or other suitable standards for data transmission.

The memory interface 506 is coupled to the memory management circuit 502 and may access the rewritable non-volatile memory module 406 and the option read-only memory 408. In other words, data to be written into the rewritable non-volatile memory module 406 is converted into a format acceptable to the rewritable non-volatile memory module 406 by the memory interface 506. The memory management circuit 502 may load an initial program stored in the option read-only memory 408 into the host system 11.

In an exemplary embodiment, the memory control circuit unit 404 further includes a buffer memory 508, a power management circuit 510, and an error checking and correcting circuit 512.

The buffer memory 508 is coupled to the memory management circuit 502 and may temporarily store data and commands from the host system 11 or data from the rewritable non-volatile memory module 406.

The power management circuit 510 is coupled to the memory management circuit 502 and may control the power of the memory storage apparatus 10.

The error checking and correcting (ECC) circuit 512 is coupled to the memory management circuit 502 and may perform an error checking and correcting operation to ensure the accuracy of data. Specifically, when the memory management circuit 502 receives a write command from the host system 11, the error checking and correcting circuit 512 may generate a corresponding error checking and correcting code (ECC code) corresponding to the data corresponding to the write command. In addition, the memory management circuit 502 may write the data corresponding to the write command and the corresponding error checking and correcting code to the rewritable non-volatile memory module 406. Subsequently, when reading the data from the rewritable non-volatile memory module 406, the memory management circuit 502 may also read the error checking and correcting code corresponding to the data, and the error checking and correcting circuit 512 may perform the error checking and correcting operation on the data being read based on the error checking and correcting code.

In the present exemplary embodiment, the error checking and correcting circuit 512 is implemented with low density parity codes (LDPC). However, in another exemplary embodiment, the error checking and correcting circuit 512 may also be implemented based on coding/decoding algorithms such as BCH codes, convolutional codes, turbo codes, bit flipping, and/or the like.

Specifically, the memory management circuit 202 may generate an ECC frame based on data received and the corresponding error checking and correcting code (also referred to as error correcting code in the following) and write the ECC frame to the rewritable non-volatile memory module 406. Then, when the memory management circuit 502 reads data from the rewritable non-volatile memory module 406, the error checking and correcting circuit 512 may verify the accuracy of the read data based on the error correcting code in the ECC frame.

In the following, the descriptions about the operations carried out by the memory management circuit 502, the host interface 504 and the memory interface 506, the buffer memory 508, the power management circuit 510, and the error checking and correcting circuit 512 may also be construed as being carried out by the memory control circuit unit 404.

FIG. 6 is a schematic block diagram illustrating a host system and a memory storage apparatus according to an exemplary embodiment.

Referring to FIG. 6, the host system 11 includes a buffer memory (i.e., RAM) 112 and may configure continuous physical addresses on the buffer memory 112 for the memory storage apparatus 10 as a host memory buffer 1121 based on a memory configuration of the memory storage apparatus 10 electrically connected with the host system 11. The host memory buffer 1121 may be provided as an expanded memory of the memory storage apparatus 10 when the host system 10 uses the memory storage apparatus 10 electrically connected with the host system 10, so as to facilitate the performance of the memory storage apparatus 10.

The memory storage apparatus 10 includes the option read-only memory 408. The option read-only memory 408 stores the initial program. In an exemplary embodiment, the memory storage apparatus 10 is a solid state drive (SSD), for example. However, the memory storage apparatus 10 may also be an electronic apparatus externally connected to the host system 11 and facilitating the performance of the host system, such as a flash drive, and the present disclosure does not intend to impose a limitation on this regard.

When the memory storage apparatus 10 is electrically connected to the host system 11, the host system 11 may scan the memory storage apparatus 10 electrically connected to the host system 11. If the option read-only memory 408 of the memory storage apparatus 10 stores the initial program, the host system 11 may load the initial program to the buffer memory 112 of the host system 11 and execute the initial program. In addition, the host system 11 may configure continuous physical addresses in the buffer memory 112 as the host memory buffer 112 based on a system configuration parameter set in the initial program and set a signature at the continuous physical addresses of the host memory buffer 1121.

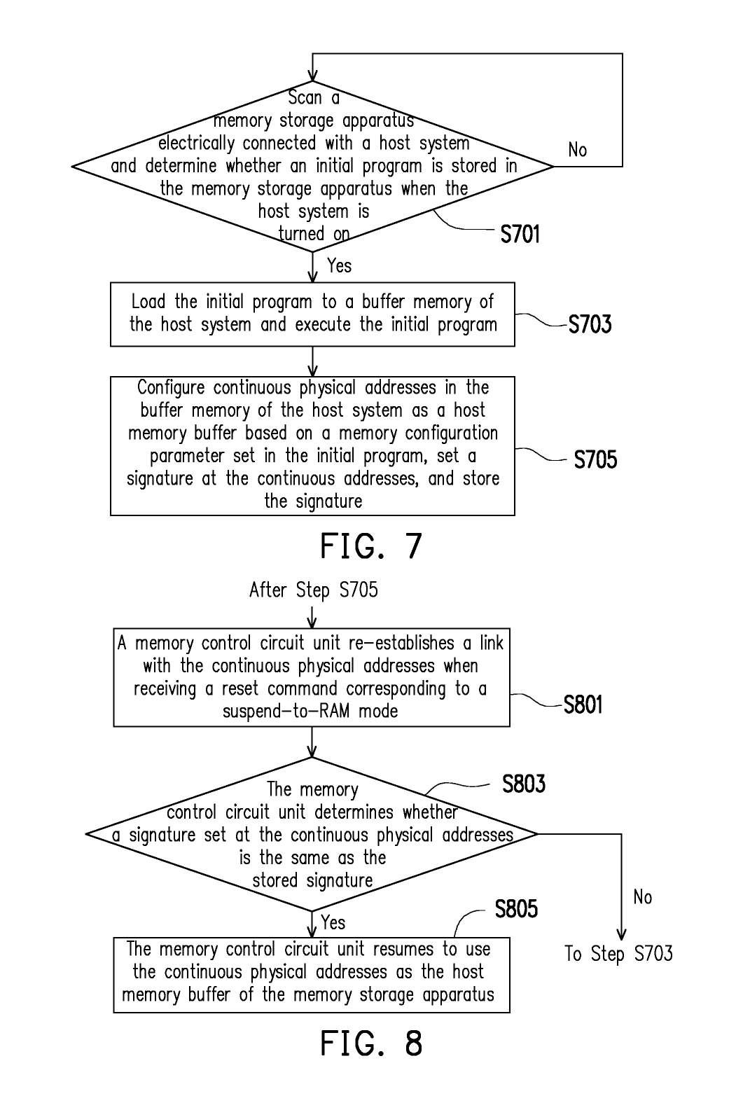

In the following, details with regard to determining whether to reconfigure the host memory buffer when resetting under different sleep modes are described in different embodiments with reference to FIGS. 7 to 11.

FIG. 7 is a schematic flowchart illustrating configuring a host memory buffer after a host system is powered on according to an exemplary embodiment.

Referring to FIG. 7, in an exemplary embodiment, the host system 11 may scan the memory storage apparatus 10 and determine whether the memory storage apparatus 10 stores the initial program when the host system 11 is powered on at Step S701.

If the memory storage apparatus 10 stores the initial program, at Step S703, the host system 11 may load the initial program to the buffer memory 112 of the host system 11 and execute the initial program.

At Step S705, the host system 11 may configure the continuous physical addresses in the buffer memory 112 of the host system 11 as the host memory buffer 1121 based on the memory configuration parameter set in the initial program, and may set a signature at the continuous physical addresses. In addition, the memory control circuit unit 404 may store the signature to the register.

FIG. 8 is a schematic flowchart when a memory control circuit unit receives a reset command corresponding to a suspend-to-RAM mode according to an exemplary embodiment.

Referring to FIG. 8, at Step S801, when the memory control circuit unit 404 receives a reset command corresponding to the suspend-to-RAM mode, the memory control circuit unit 404 may re-establish the link with the continuous physical addresses.

At Step S803, the memory control circuit unit 404 may determine whether the signature set at the continuous addresses is the same as the stored signature. If the signature set at the continuous addresses is different from the stored signature, Step S703 is carried out.

If the signature set at the continuous addresses is the same as the stored signature, the memory control circuit unit 404 may resume to use the continuous physical addresses as the host memory buffer 1121 of the memory storage apparatus 10 at Step S805.

More specifically, when the memory control circuit unit 404 receives the reset command corresponding to the suspend-to-RAM mode, the host system 11 is reset from an S3 (suspend to ram, also referred to as STR) sleep mode. In the S3 sleep mode, power is only supplied to the host memory buffer 1121 of the host system 11, and power to other components of the host system 11 and the memory storage apparatus 10 is turned off Under the circumstance, work state information before the host system 11 enters the S3 mode is stored in the host memory buffer 1121. After being reset from the S3 sleep mode, the host system 11 may directly access information from the host memory buffer 1121 and restore the host system 11 to the work state before the host system 11 enters the S3 mode. In other words, the memory control circuit unit 404 is able to determine whether the host memory buffer 1121 configured before the host system 11 enters the S3 sleep mode may be directly used simply by comparing whether the signature set at the continuous physical addresses after the host system 11 is reset is the same as the signature stored before the host system 11 is reset. Thus, the host system 11 may directly enter the operating system without loading the initial program again or reconfiguring the host memory buffer 1121.

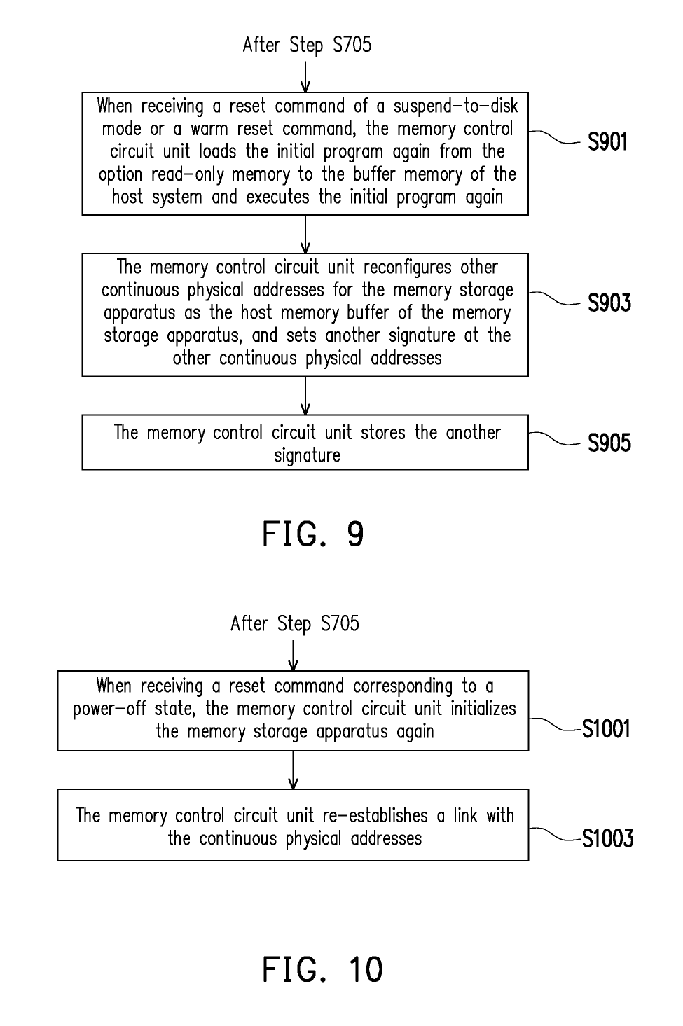

FIG. 9 is a schematic flowchart when a memory control circuit unit receives a reset command of a suspend-to-disk mode or a warm reset command according to an exemplary embodiment.

Referring to FIG. 9, when the memory control circuit unit 404 receives a reset command of the suspend-to-disk mode or a wane reset command, at Step S901, the memory control circuit unit 404 may load the initial program again from the option read-only memory 408 to the buffer memory 112 of the host system 11 and execute the initial program again.

At Step S903, the memory control circuit unit 404 reconfigures other continuous physical addresses for the memory storage apparatus 10 as the host memory buffer 1121 of the memory storage apparatus 10 and set another signature at the other continuous physical addresses.

At Step S905, the memory control circuit unit 404 stores the another signature.

More specifically, when the memory control circuit unit 404 receives the reset command of the suspend-to-disk mode, the host system 11 is reset from an S4 (suspend to disk, also referred to as STD) sleep mode. In the S4 sleep mode, power is only supplied to the memory storage apparatus 10. Meanwhile, the host system 11 may store the work state information before the host system enters the S4 sleep mode in the memory storage apparatus 10. After the host system 11 is reset from the S4 sleep mode, the initial program of the memory storage apparatus 10 needs to be loaded again and executed to start the operating system. Therefore, the host system 11 needs to reconfigure the host memory buffer 1121 at other continuous physical addresses for the memory storage apparatus 10.

FIG. 10 is a schematic flowchart when a memory control circuit unit receives a reset command corresponding to a power-off state according to an exemplary embodiment.

Referring to FIG. 10, when the memory control circuit unit 404 receives a reset command corresponding to a power-off state, at Step S1001, the memory control circuit unit 404 may initialize the memory storage apparatus 10 again. As an example, the power-off state may include a device power-off state (D3), an NVM subsystem reset (NSSR), or a function level reset (FLR).

At Step S1003, the memory control circuit unit 404 may re-establish a link with the continuous physical addresses.

Specifically, after the memory storage apparatus 10 is powered on again, the memory control circuit unit 404 may receive a reset command corresponding to the power-off state. Under the circumstance, the memory storage apparatus 10 and a PCIe bus are initialized again, and the memory control circuit unit 404 re-establishes a link with the continuous physical addresses. In other words, since the host system 11 does not require to be reset, the memory control circuit unit 404 only needs to re-establish a link with the continuous physical addresses to directly use the continuous physical addresses as the host memory buffer 1121 of the memory storage apparatus 10.

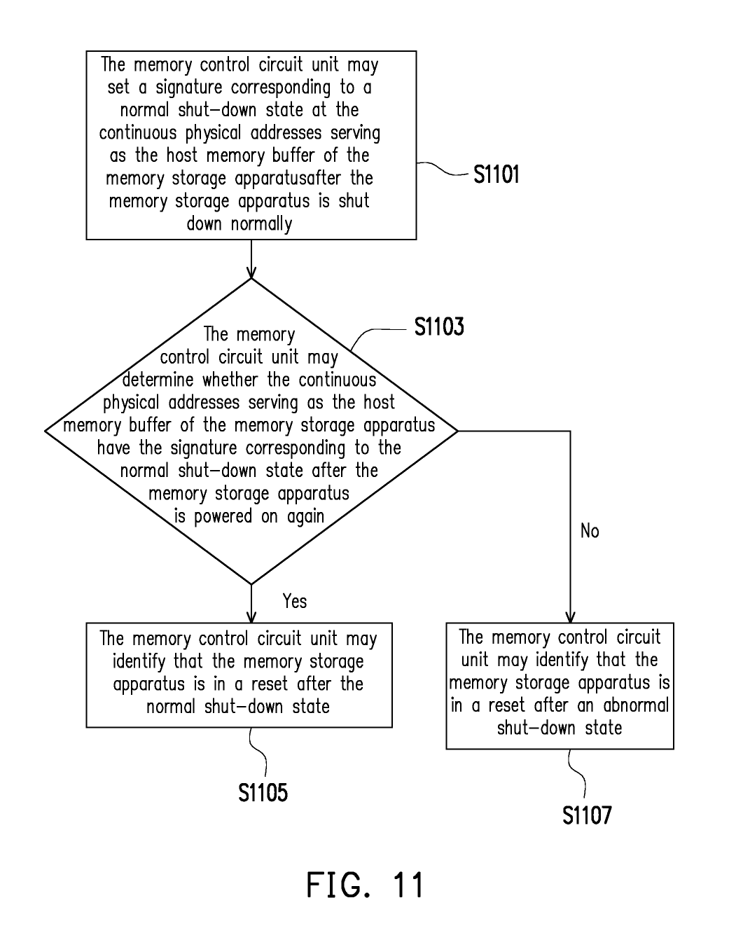

FIG. 11 is a schematic flowchart illustrating that a memory control circuit unit determines whether a memory storage apparatus is shut down normally according to an exemplary embodiment.

Referring to FIG. 11, after the memory storage apparatus 10 is shut down normally, at Step S1101, the memory control circuit unit 404 may set a mark corresponding to a normal shut-down state at the continuous physical addresses serving as the host memory buffer 1121 of the memory storage apparatus 10.

After the memory storage apparatus 10 is powered on again, at Step S1103, the memory control circuit unit 404 may determine whether the continuous physical addresses serving as the host memory buffer 1121 of the memory storage apparatus 10 have the mark corresponding to the normal shut-down state.

If the continuous physical addresses serving as the host memory buffer 1121 of the memory storage apparatus 10 have the mark corresponding to the normal shut-down state, at Step S1105, the memory control circuit unit 404 may identify that the memory storage apparatus 10 is in a reset after the normal shut-down state.

If the continuous physical addresses serving as the host memory buffer 1121 of the memory storage apparatus 10 do not have the mark corresponding to the normal shut-down state, at Step S1107, the memory control circuit unit 404 may identify that the memory storage apparatus 10 is in a reset after an abnormal shut-down state.

In view of the foregoing, according to the method for configuring the host memory buffer, the memory storage apparatus, and the memory control circuit unit of the exemplary embodiments of the disclosure, whether the host memory buffer needs to be reconfigured for the memory storage apparatus is determined by using the option read-only memory and based on the memory configuration parameter of the memory storage apparatus. Accordingly, the host memory buffer is able to be configured flexibly.

The previously described exemplary embodiments of the present disclosure have the advantages aforementioned, wherein the advantages aforementioned not required in all versions of the disclosure.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims and their equivalents.

What is claimed is:

1. A method for configuring a host memory buffer, comprising:
loading an initial program stored in an option read-only memory of a memory storage apparatus to a buffer memory of a host system;
executing the initial program to configure continuous physical addresses in the buffer memory of the host system for the memory storage apparatus as a host memory buffer of the memory storage apparatus and setting a signature at the continuous physical addresses; and
storing the signature in the memory storage apparatus.

2. The method for configuring the host memory buffer as claimed in claim 1, further comprising:
re-establishing a link with the continuous physical addresses when receiving a reset command corresponding to a suspend-to-RAM mode, and determining whether the signature set at the continuous physical addresses is the same as the stored signature; and
resuming to use the continuous physical addresses as the host memory buffer of the memory storage apparatus if the signature set at the continuous physical addresses is the same as the stored signature.

3. The method for configuring the host memory buffer as claimed in claim 1, further comprising:
loading the initial program again from the option read-only memory of the memory storage apparatus to the buffer memory of the host system when a reset command corresponding to a suspend-to-disk mode or a warm reset command is received;
executing the initial program again to configure other continuous physical addresses in the buffer memory of the host system for the memory storage apparatus as the host memory buffer of the memory storage apparatus and setting another signature at the other continuous physical addresses; and
storing the another signature in the memory storage apparatus.

4. The method for configuring the host memory buffer as claimed in claim 1, further comprising:
initializing the memory storage apparatus again and re-establishing a link with the continuous physical addresses when a reset command corresponding to a power-off state is received.

5. The method for configuring the host memory buffer as claimed in claim 4, wherein the power-off state includes a device power-off state, an NVM subsystem reset (NSSR), or a function level reset (FLR).

6. The method for configuring the host memory buffer as claimed in claim 1, further comprising:
setting a mark corresponding to a normal shut-down state at the continuous physical addresses serving as the host memory buffer of the memory storage apparatus after the memory storage apparatus is shut down normally.

7. The method for configuring the host memory buffer as claimed in claim 6, further comprising:
determining whether the continuous physical addresses serving as the host memory buffer of the memory storage apparatus has the mark corresponding to the normal shut-down state after the memory storage apparatus is powered on again; and
identifying that the memory storage apparatus is in a restart after the normal shut-down state if the continuous physical addresses serving as the host memory buffer of the memory storage apparatus stores the mark corresponding to the normal shut-down state.

8. A memory storage apparatus, comprising:
a connection interface unit, configured to be electrically connected to a host system;
a rewritable non-volatile memory module;
an option read-only memory, storing an initial program, wherein when the host system is powered on, the initial program is loaded to a buffer memory of the host system and the initial program is executed to configure continuous physical addresses in the buffer memory of the host system as a host memory buffer, and a signature is set at the continuous physical addresses; and
a memory control circuit unit, electrically connected to the option read-only memory, the connection interface unit, and the rewritable non-volatile memory module and configured to store the signature.

9. The memory storage apparatus as claimed in claim 8, wherein when the memory control circuit unit receives a reset command corresponding to a suspend-to-RAM mode, the memory control circuit unit is configured to re-establish a link with the continuous physical addresses and determine whether the signature set at the continuous physical addresses is the same as the stored signature, and
the memory control circuit unit resumes to use the continuous physical addresses as the host memory buffer of the memory storage apparatus if the signature set at the continuous physical addresses is the same as the stored signature.

10. The memory storage apparatus as claimed in claim 8, wherein when the memory control circuit unit receives a reset command of a suspend-to-disk or a warm reset command,
the memory control circuit unit is further configured to load the initial program again from the option read-only memory to the buffer memory of the host system and execute the initial program again,
the memory control circuit unit is further configured to reconfigure other continuous physical addresses for the memory storage apparatus as the host memory buffer of the memory storage apparatus and set another signature at the other continuous physical addresses, and
the memory control circuit unit is further configured to store the another signature.

11. The memory storage apparatus as claimed in claim 8, wherein when the memory control circuit unit receives a reset command corresponding to a power-off state,
the memory control circuit unit is further configured to initialize the memory storage apparatus again and re-establish a link with the continuous physical addresses.

12. The memory storage apparatus as claimed in claim 11, wherein the power-off state includes a device power-off state, an NVM subsystem reset (NSSR), or a function level reset (FLR).

13. The memory storage apparatus as claimed in claim 8, wherein after the memory storage apparatus is shut down normally,
the memory control circuit unit is further configured to set a mark corresponding to a normal shut-down state at the continuous physical addresses serving as the host memory buffer of the memory storage apparatus.

14. The memory storage apparatus as claimed in claim 13, wherein after the memory storage apparatus is powered on again,
the memory control circuit unit is further configured to determine whether the continuous physical addresses serving as the host memory buffer of the memory storage apparatus has the mark corresponding to the normal shut-down state, and
the memory control circuit unit is further configured to identify that the memory storage apparatus is in a restart after the normal shut-down state if the continuous physical addresses serving as the host memory buffer of the memory storage apparatus stores the mark corresponding to the normal shut-down state.

15. A memory control circuit unit, comprising:
a host interface, configured to be electrically connected to a host system;
a memory interface, configured to be electrically connected to a rewritable non-volatile memory module and an option read-only memory storing an initial program, wherein when the host system is powered on, the initial program is loaded to a buffer memory of the host system and the initial program is executed to configure continuous physical addresses in the buffer memory of the host system as a host memory buffer, a signature is set at the continuous physical addresses, and the signature is stored in a register.

16. The memory control circuit unit as claimed in claim 15, further comprising a memory management circuit electrically connected to the host interface and the memory interface,
wherein when the memory management circuit receives a reset command corresponding to a suspend-to-RAM mode, the memory management circuit is configured to re-establish a link with the continuous physical addresses and determine whether the signature set at the continuous physical addresses is the same as the stored signature, and
the memory management circuit resumes to use the continuous physical addresses as the host memory buffer of the memory storage apparatus if the signature set at the continuous physical addresses is the same as the stored signature.

17. The memory control circuit unit as claimed in claim 15, wherein when the memory management circuit receives a reset command of a suspend-to-disk or a warm reset command,
the memory management circuit is further configured to load the initial program again from the option read-only memory to the buffer memory of the host system and execute the initial program again,
the memory management circuit is further configured to reconfigure other continuous physical addresses for the memory storage apparatus as the host memory buffer of the memory storage apparatus and set another signature at the other continuous physical addresses, and
the memory management unit is further configured to store the another signature.

18. The memory control circuit unit as claimed in claim 15, wherein when the memory management circuit receives a reset command corresponding to a power-off state,
the memory management circuit is further configured to initialize the memory storage apparatus again and re-establish a link with the continuous physical addresses.

19. The memory control circuit unit as claimed in claim 18, wherein the power-off state includes a device power-off state, an NVM subsystem reset (NSSR), or a function level reset (FLR).

20. The memory control circuit unit as claimed in claim 15, wherein after the memory storage apparatus is shut down normally, the memory management circuit is further configured to set a mark
corresponding to a normal shut-down state at the continuous physical addresses serving as the host memory buffer of the memory storage apparatus.

21. The memory control circuit unit as claimed in claim 20, wherein after the memory storage apparatus is powered on again,
the memory management circuit is further configured to determine whether the continuous physical addresses serving as the host memory buffer of the memory storage apparatus has the mark corresponding to the normal shut-down state, and
the memory management circuit is further configured to identify that the memory storage apparatus is in a restart after the normal shut-down state if the continuous physical addresses serving as the host memory buffer of the memory storage apparatus stores the mark corresponding to the normal shut-down state.
